(19) United States
(12) Patent Application Publication
(10) Pub. No.: US 2021/0355926 A1
(43) Pub. Date: Nov. 18, 2021

(54) GAS COMPRESSOR AND PRODUCTION METHOD FOR GAS COMPRESSOR

(71) Applicant: KAJI TECHNOLOGY CORPORATION, Osaka (JP)

(72) Inventors: Yasutaka NAKATANI, Sakai-shi, Osaka (JP); Takashi MATSUOKA, Kobe-shi, Hyogo (JP)

(21) Appl. No.: 17/278,000

(22) PCT Filed: Jan. 15, 2020
(86) PCT No.: PCT/JP2020/000944

§ 371 Date: Mar. 19, 2021

(30) Foreign Application Priority Data
Jan. 16, 2019 (JP) 2019-005223

(51) Int. Cl. F04B 39/00; F04B 39/12; F16J 9/26; F16J 15/18; C10M 103/02; C01B 32/05

(52) U.S. Cl. CPC F04B 39/0005; F04B 39/126; F16J 9/26; C10N 2040/30; C10M 103/02; C01B 32/05; C10M 2201/0413; F16J 15/18

(57) ABSTRACT

A gas compressor compressing gas includes a cylinder liner, a piston member, and a first sliding member. The piston member includes a piston reciprocating in an inner space of the cylinder liner, and a piston rod connected to the piston. The first sliding member is made of a resin, has a ring shape, and is provided on one of the piston member and the cylinder liner. The first sliding member slides relatively against a reception member while another of the piston member and the cylinder liner serves as the reception member that receives sliding. An amorphous carbon film is formed on a sliding surface of each of the first sliding member and the reception member. A carbon content in the amorphous carbon film formed on each of the sliding surfaces is larger in its surface part than in its inner part on an inner side of the surface part.

### CROSS-REFERENCE TO RELATED APPLICATIONS

This application is a National Stage Entry application of PCT International Application No. PCT/JP2020/000944, filed on Jan. 15, 2020, which claims the priority benefit of Japanese Patent Application No. 2019-005223, filed on Jan. 16, 2019, the entire contents of both of which are hereby incorporated by reference.

### BACKGROUND

### 1. Technical Field

The present invention relates to a gas compressor that compresses gas and to a method for manufacturing the gas compressor.

### 2. Description of the Background

A gas compressor that compresses gas includes a cylinder liner and a piston member. The piston member includes a piston and piston rod. The piston reciprocates in an inner space of the cylinder liner. The piston rod is connected to the piston. Resin-made rings that generate low friction force are used at parts where the piston member contacts with the cylinder liner. The resin-made rings are a piston ring, a rider ring, rod packing, and the like, for example.

The rider ring is a sliding member for preventing metal contact between the piston and the cylinder liner. The piston ring is a sliding member having a function of sealing for preventing leakage of compressed gas. These sliding members are provided on an outer circumference of the piston. The rod packing is a sliding member having a function of sealing for preventing gas leakage along the piston rod.

An oil-free gas compressor is used as the gas compressor in order that gas compressed by the gas compressor is prevented from containing an oil component. No lubrication oil is thus supplied to surfaces of the piston ring, the rider ring, and the rod packing. For this reason, the piston ring, the rider ring, and the rod packing are formed of a material having a low friction coefficient to reduce friction with a subjected-to-sliding member, i.e., a reception member that receives sliding. Examples used as this material are resins such as polytetrafluoroethylene (PTFE), polyetheretherketone (PEEK), and polyimide. These materials have low friction with the metal-made reception member, thus lengthening wear lives.

A reciprocation compressor used under a high-pressure operation condition includes a sliding surface. Wear resistance of the sliding surface can be maintained for a long period of time by a known sealing element (Japanese Patent Application Laid-open Publication No. 2011-38107), for example.

Specifically, the sealing element is constituted by a wear-resistant polymer matrix. Examples of the polymer matrix include PEEK, polybutadiene-styrene (PBS), and PTFE. The polymer matrix includes a plurality of dispersed microcapsules inside. The microcapsules enclose lubricants inside.

### BRIEF SUMMARY

However, the sealing element cannot be used in an oil-free gas compressor because of the lubricants dispersed inside the sealing element. Particularly when hydrogen is compressed to high pressure by the compressor and charged in a fuel cell vehicle, application of the above-described sealing element is inappropriate because of a request for high-purity quality of the hydrogen.

An object of the present disclosure is, in view of the above, to provide a gas compressor and a gas compressor manufacturing method that enable compressed gas of high purity to be sent out when compressing the gas and can extend a sliding-member replacement life attributed to wear.

One aspect of the present disclosure is a gas compressor that compresses gas. The gas compressor includes:

a cylinder liner;

a piston member including,
a piston configured so as to reciprocate in an inner space of the cylinder liner, and
a piston rod connected to the piston; and
   a first sliding member made of a resin, having a ring shape, and provided on one of the piston member and the cylinder liner, the first sliding member configured to slide relatively against a reception member while another of the piston member and the cylinder liner serves as the reception member that receives sliding.

An amorphous carbon film is formed on a sliding surface of each of the first sliding member and the reception member.

A carbon content in the amorphous carbon film formed on each of the sliding surfaces is larger in a surface part than in an inner part on an inner side of the surface part, the surface part and the inner part belonging to the amorphous carbon film.

Preferably, the first sliding member is formed of a resin material containing an additive that contains sulfur, the amorphous carbon film formed on each of the sliding surfaces is free of sulfur, and a pipe connected to a hydrogen gas source is connected to a compression chamber of the gas compressor.

Preferably, the first sliding member is formed of a resin material containing an additive that contains sulfur, and the amorphous carbon film formed on each of the sliding surfaces is free of sulfur.

Preferably, the first sliding member is formed of a resin material containing fluorine, and a fluorine content in the amorphous carbon film formed on each of the sliding surfaces is smaller in the surface part than in the inner part on an inner side of the surface part.

Preferably, the first sliding member is a desulfurized member.

Another aspect of the present disclosure is a gas compressor that compresses gas. The gas compressor includes:

a cylinder liner;

a piston member including
a piston configured to reciprocate in an inner space of the cylinder liner, and
a piston rod connected to the piston;

a first sliding member made of a resin, having a ring shape, and provided on one of the piston member and the cylinder liner, the first sliding member configured to slide relatively against a reception member while another of the piston member and the cylinder liner serves as the reception member that receives sliding; and

a second sliding member having a ring shape and provided on the one of the piston member and the cylinder liner, the second sliding member configured to slide relatively against the reception member and thereby supply graphite for forming an amorphous carbon film, a graphite content in the second sliding member being larger than in the first sliding member.

Still another aspect of the present disclosure is a method for manufacturing a gas compressor configured to compress gas. The gas compressor includes: a cylinder liner; a piston member including a piston configured to reciprocate in an inner space of the cylinder liner, and a piston rod connected to the piston; and a first sliding member made of a resin, having a ring shape, and provided on one of the piston member and the cylinder liner, the first sliding member configured to slide relatively against a reception member while another of the piston member and the cylinder liner serves as the reception member that receives sliding,

The method for manufacturing the gas compressor includes:

forming a carbon film on a surface of the first sliding member or the reception member, the carbon film containing carbon as a main component; and

driving the piston member so as to slide the first sliding member relatively against the reception member, thereby causing an amorphous carbon film to be formed, from the carbon film, on a sliding surface of the first sliding member and a sliding surface of the reception member, the amorphous carbon film being more hardened than the carbon film.

Yet another aspect of the present disclosure is a method for manufacturing a gas compressor configured to compress gas. The gas compressor includes: a cylinder liner; a piston member including a piston configured to reciprocate in an inner space of the cylinder liner, and a piston rod connected to the piston; a first sliding member made of a resin, having a ring shape, and provided on one of the piston member and the cylinder liner, the first sliding member configured to slide relatively against a reception member while another of the piston member and the cylinder liner serves as the reception member that receives sliding; and a second sliding member made of a resin, having a ring shape, and configured to slide relatively against the reception member, a carbon content in the second sliding member being larger than in the first sliding member.

The method for manufacturing the gas compressor includes driving the piston member so as to slide the first sliding member and the second sliding member relatively against the reception member, thereby causing an amorphous carbon film to be formed on a sliding surface of the reception member, a sliding surface of the first sliding member, and a sliding surface of the second sliding member, the amorphous carbon film being formed of carbon derived from the second sliding member.

Preferably, a graphite content in the second sliding member is larger than in the first sliding member, and the second sliding member supplies the graphite, thereby forming the amorphous carbon film.

Preferably, the method includes exposing the second sliding member to a hydrogen atmosphere before incorporating the second sliding member into the gas compressor.

Preferably, the method includes exposing the first sliding member to a hydrogen atmosphere before incorporating the first sliding member into the gas compressor.

Preferably, the first sliding member is formed of a resin material containing an additive that contains sulfur, and the amorphous carbon film formed on each of the sliding surfaces is free of sulfur.

Preferably, the gas compressor sucks hydrogen gas, compresses the sucked hydrogen gas, and sends out the compressed hydrogen gas.

The gas compressor and the gas compressor manufacturing method described above enable compressed gas of high purity to be sent out, and can extend a sliding-member replacement life attributed to wear.

### BRIEF DESCRIPTION OF DRAWINGS

FIG. 1 is a configuration diagram illustrating an entire configuration of a gas compressor according to one embodiment.

FIG. 2 is an enlarged view illustrating the vicinity of a piston and a piston rod in the one embodiment.

FIG. 3A to FIG. 3C represent one example of XPS measurement results of an amorphous carbon film on a sliding surface of a reception member.

FIG. 4A to FIG. 4C illustrate examples of forming amorphous carbon films, using a piston ring as a sliding member and using a cylinder liner as a reception member.

### DETAILED DESCRIPTION

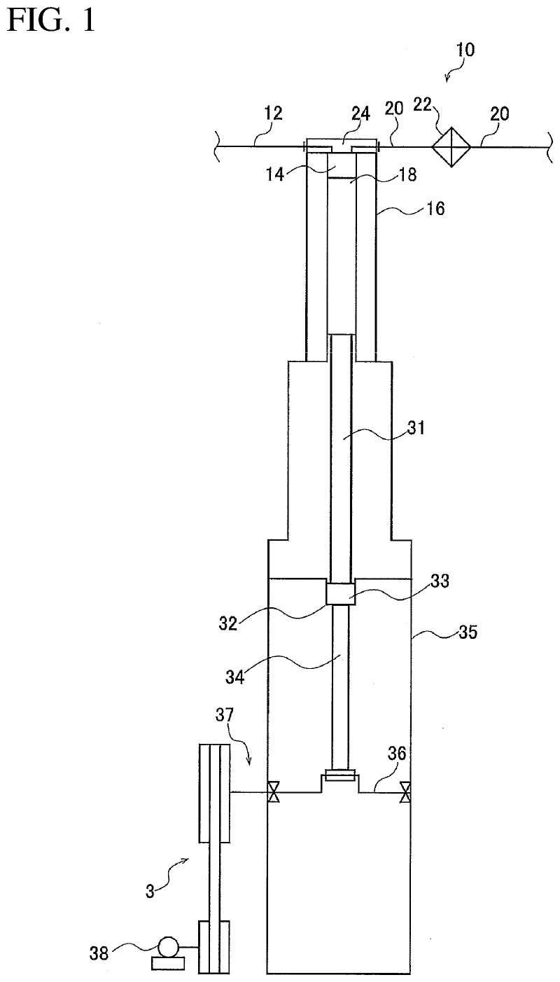

The following describes a gas compressor according to one embodiment, with reference to the drawings. FIG. 1 is a configuration diagram illustrating an entire configuration of the gas compressor 10 according to the one embodiment of the present disclosure. The gas compressor 10 is driven by a drive unit 3.

The gas compressor 10 includes a cylinder 16 and a piston 18. The cylinder 16 includes a compression chamber 14 (an inner space of the cylinder) connected to a tank (gas source) via a suction pipe 12. The piston 18 is arranged inside the cylinder 16 so as to be reciprocally slidable. Specifically, the cylinder 16 includes a cylinder liner inside, and the piston 18 reciprocates in an inner space of the cylinder liner. Reciprocal sliding of the piston 18 causes gas stored in the tank such as hydrogen gas to be sucked into the compression chamber 14 of the cylinder 16 and compressed to high pressure (e.g., in a range of 20 to 80 MPa). A cylinder head 24 is provided on an upper side of the compression chamber 14. The cylinder head 24 is provided with a suction valve and a discharge valve for gas. The compressed gas is sent out through the discharge valve and a discharge pipe 20. The discharge pipe 20 is provided with a cooler 22 for cooling the compressed gas. The tank is a hydrogen gas source that stores hydrogen gas.

The drive unit 3 includes a piston rod 31, a crosshead 33, a connecting rod 34, a crankshaft 36, a power transmission mechanism 37, and a drive motor 38.

One end of the piston rod 31 is connected to a base end of the piston 18.

The crosshead 33 is connected to the other end of the piston rod 31 and arranged inside a crosshead guide 32 so as to be reciprocally slidable.

One end of the connecting rod 34 is connected to the crosshead 33.

The other end of the connecting rod 34 is connected to the crankshaft 36. The crankshaft 36 is supported by rotary bearings of a crankcase 35.

The power transmission mechanism 37 includes pulleys and a belt.

The drive motor 38 is connected to the crankshaft 36 via the power transmission mechanism 37 so as to enable power transmission. Rotational force of the drive motor 38 accordingly causes rotation of the crankshaft 36 and reciprocal sliding of the crosshead 33 in the crosshead guide 32, consequently causing reciprocal sliding of the piston 18 inside the cylinder 16.

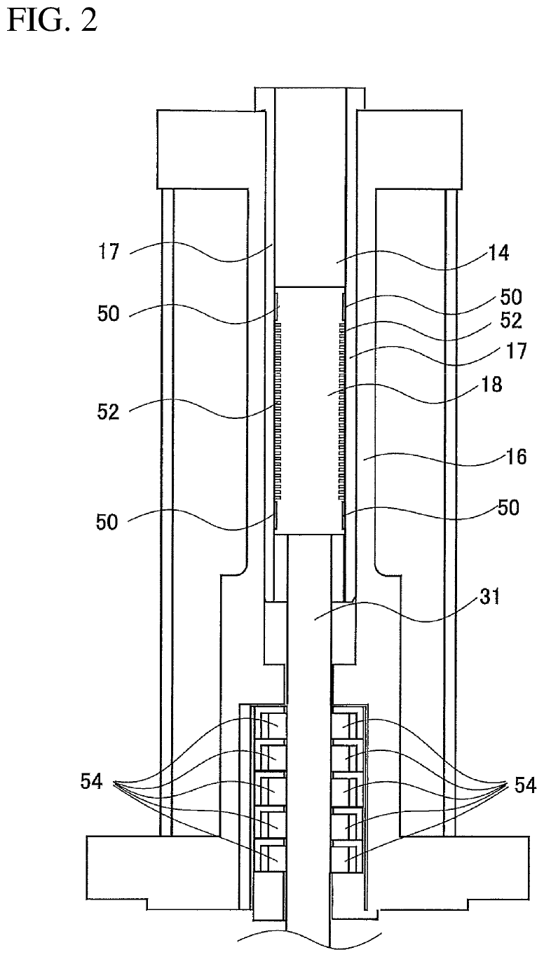

FIG. 2 is an enlarged view illustrating the vicinity of the piston 18 and the piston rod 31. The piston 18 is provided with rider rings 50. The rider ring 50 is a sliding member for preventing metal contact between the piston 18 and the cylinder liner 17. The rider ring 50 is a ring-shaped member made of a resin and provided on the piston 18. The rider ring 50 slides relatively against the cylinder liner 17 while the cylinder liner 17 serves as a subjected-to-sliding member, i.e., a reception member. The rider ring 50 is arranged in a groove provided on an outer circumference of the piston 18.

The piston 18 is provided with a plurality of piston rings 52. The piston ring 52 is provided on the piston 18 so as to prevent compressed gas inside the compression chamber 14 from leaking toward rod packing 54. The piston ring 52 is a ring-shaped member made of a resin and closely contacting with the cylinder liner 17. The piston ring 52 slides relatively against the cylinder liner 17 while the cylinder liner 17 serves as a reception member. The piston ring 52 is arranged in a groove provided on the outer circumference of the piston 18.

The cylinder 16 is provided with a plurality of pieces of the rod packing 54. The rod packing 54 is a ring-shaped member made of a resin. The rod packing 54 is provided on a bottom side so as to prevent compressed gas inside the compression chamber 14 from leaking to a lower side in FIG. 1. The rod packing 54 closely contacts with the piston rod 31. The rod packing 54 slides relatively against the piston rod 31 while the piston rod 31 serves as a reception member. The rod packing 54 is arranged in a space provided on the bottom side in the cylinder 16.

In other words, the rider ring 50, the piston ring 52, and the rod packing 54 are the ring-shaped resin-made sliding members that slide relatively against the reception members while the cylinder liner 17 and the piston rod 31 serve as the reception members.

The sliding member is made of a resin to reduce a coefficient of friction with the reception member. Examples of the resin used for the sliding member include polytetrafluoroethylene (PTFE), polyetheretherketone (PEEK), and polyimide. These resins each contain an additive containing a sulfur component to improve durability. Examples of the additive include a polyphenylene sulfide (PPS) resin and molybdenum disulfide.

An amorphous carbon film is formed on sliding surfaces of both the sliding member and the reception member.

A carbon content in the amorphous carbon film formed on each of these sliding surfaces is larger in its surface part than in its inner part on an inner side of the surface part. The amorphous carbon film has a high affinity with the resin and is less likely to be peeled off than a metal-made member. This amorphous carbon film is diamond-like carbon and has high hardness. The diamond-like carbon has a low friction coefficient. The amorphous carbon film accordingly has a low coefficient of friction with the reception member, resulting in that a sliding-member life length attributed to wear is extended.

Such an amorphous carbon film is made by forming a carbon film and driving the piston 18. Specifically, the carbon film yet to turn into the amorphous carbon film is formed on one or both of the sliding surface of the sliding member and the sliding surface of the reception member, and the piston 18 is then driven inside the cylinder liner 17 for hydrogen gas as compression target gas, as described below.

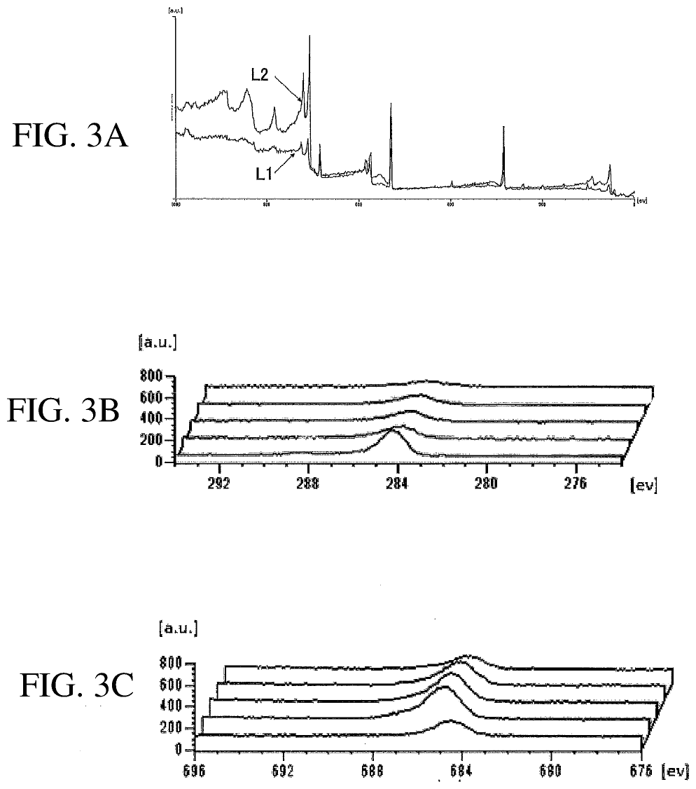

A composition of the amorphous carbon film can be examined by X-ray photoelectron spectroscopy (XPS). The XPS is measurement for a sample on which an amorphous carbon film has been formed. The measurement includes irradiating the sample with an X ray in a vacuum, thereby causing photoelectrons to be emitted from an inside of the sample. The measurement includes measuring kinetic energy of the emitted photoelectrons by spectroscopy, thereby enabling analysis of constituent elements of the sample and electron states of the constituent elements. FIG. 3A to FIG. 3C represent one example of XPS measurement results of the amorphous carbon film on the sliding surface of the reception member. The example illustrated in FIG. 3A to FIG. 3C used PTFE as a resin material for the sliding member. The PTFE contained PPS as an additive.

The line L1 in FIG. 3A represents the XPS measurement result of a surface part of the amorphous carbon film. The line L1 represents information of the part ranging from a surface to a depth of several nanometers. The line L2 represents information of a part where plasma removed a surface part in the amorphous carbon film by 45.9 nm.

FIG. 3B and FIG. 3C are partially enlarged illustrations of kinetic energy of the photoelectrons in the XPS measurement results.

FIG. 3B illustrates a partial range of the kinetic energy. This range corresponds to the kinetic energy of the photoelectrons emitted from carbon (SP³ orbital). The five lines in FIG. 3B represent measurement results after plasma removed surface parts. Specifically, the lines depicted in FIG. 3B represent the measurement results after the removal of 0 mm (no removal), 2.7 nm, 8.1 nm, 13.5 nm, and 45.9 nm in the order from the front side to the back side of FIG. 3B. The kinetic energy of the photoelectrons emitted from carbon (SP³ orbital) forms a peak of light intensity at 285 [eV]. Meanwhile, kinetic energy of the photoelectrons emitted from carbon (SP² orbital) forms a different peak of light intensity. Carbon (SP³ orbital) can be recognized accordingly. The most front line among the five lines represents the measurement result of the surface part. As the line shifts from the front-side one to the back-side one, the line represents the measurement result of the deeper part in the amorphous carbon film. A carbon (SP³ orbital) content is the largest in the front part, and a carbon (SP³ orbital) content of the inner part is lower than that of the surface part, as can be understood from FIG. 3B. It can be said from this that diamond-like carbon, i.e., the amorphous carbon film containing a large content of carbon (SP³ orbital) is formed on the sliding surface of the reception member. Raman spectroscopy analysis (a method of separating Raman scattering light generated from a sample, into spectral components to be analyzed) has confirmed that such an amorphous carbon film on the sliding surface of the reception member is formed not only on the sliding surface of the reception member but also on the sliding surface of the sliding member. The amorphous carbon film is thus formed on the sliding surface of each of the reception member and the sliding member. These amorphous carbon films each contain carbon (SP³ orbital) of which content is larger in its surface part than in its inner part. These amorphous carbon films each have a low friction coefficient. Wear lives of the ring-shaped resin-made members are extended accordingly.

FIG. 3C illustrates a partial range of the kinetic energy. This range corresponds to the kinetic energy of the photoelectrons emitted from fluorine. The five lines in FIG. 3C represent measurement results after plasma removed surface parts. The lines depicted in FIG. 3C also represent the measurement results after the removal of 0 mm (no removal), 2.7 nm, 8.1 nm, 13.5 nm, and 45.9 nm in the order from the front side to the back side of FIG. 3C, as in FIG. 3B. In other words, the most front line among the five lines represents the measurement result of the surface part. As the line shifts from the front-side one to the back-side one, the line represents the measurement result of the deeper part in the amorphous carbon film. The sliding member is made of PTFE, i.e., formed of a resin material containing fluorine. Accordingly, the amorphous carbon film formed on each of the sliding surfaces also contains fluorine. A fluorine content in the amorphous carbon film is, however, smaller in its surface part than in its inner part on an inner side of the surface part, as can be understood from FIG. 3C. It can be thus said that the surface part in the amorphous carbon film contains, as a component, a large content of carbon (SP³ orbital), and includes a large number of carbon bonds based on the SP³ orbital.

The region in the vicinity of 170 [eV] illustrated in FIG. 3A is a region corresponding to the kinetic energy of the photoelectrons emitted from sulfur. This vicinity in FIG. 3A, however, includes no peaks of light intensity. A sulfur-containing additive such as PPS is added to PTFE in order to improve durability, but is absent in the amorphous carbon film. It is thus supposed that when the piston 18 is driven inside the cylinder liner 17 for hydrogen gas as compression target gas, the sliding member is partially worn in the process of formation of the amorphous carbon film, and at this time, the sulfur in the PPS reacts with the hydrogen gas and is thereby mixed as hydrogen sulfide into the compressed gas.

Thus, even when the sliding member is formed of a resin material containing fluorine, a fluorine content in the amorphous carbon film formed on each of the sliding surfaces is preferably smaller in its surface part than in its inner part on an inner side of the surface part to prevent the amorphous carbon film from containing impurities such as fluorine and sulfur. Even when the sliding member is formed of a resin material containing an additive that contains sulfur, the amorphous carbon film formed on each of the sliding surfaces is preferably free of sulfur.

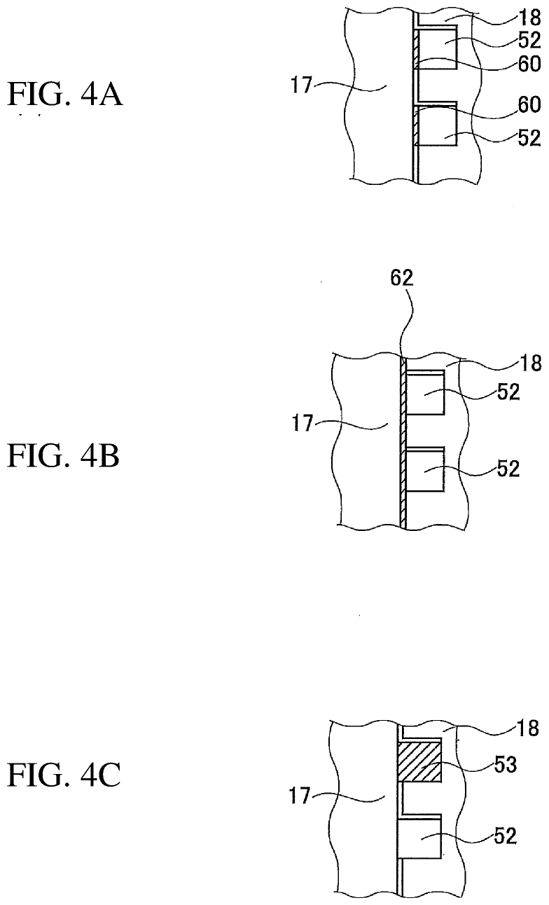

Methods as illustrated in FIG. 4A to FIG. 4C are preferably used for efficiently making such amorphous carbon films.

Specifically, a carbon film containing carbon as a main component (the main component is a component whose percentage mass content exceeds 50%) is formed on a surface of the sliding member or the reception member. The piston member is then driven, causing the sliding member to slide relatively against the reception member. As a result, an amorphous carbon film hardened more than the carbon film is formed on the sliding surface of the sliding member and the sliding surface of the reception member.

Thereby, a carbon content in the amorphous carbon film can be made larger in its surface part than in its inner part on an inner side of the surface part.

FIG. 4A to FIG. 4C illustrate examples of forming the amorphous carbon films, using the piston ring 52 as the sliding member and using the cylinder liner 17 as the reception member. FIG. 4A illustrates the example of forming a carbon film 60 on the sliding surface belonging to the piston ring 52 and contacting with the cylinder liner 17. The carbon film 60 contains carbon as a main component. The gas compressor is made to operate for generating compressed gas. The piston ring 52 thereby slides against the cylinder liner 17, resulting in that a tribochemical reaction turns the carbon film 60 into the amorphous carbon films. The tribochemical reaction is a chemical reaction that does not normally occur, and is induced as follows. The sliding surface sliding with friction contacts at a contact part much smaller than a presumed contact area, so that the contact part is exposed to high pressure and temperature due to the friction, thereby inducing the tribochemical reaction. Thus, forming the carbon film 60 on the sliding surface of the piston ring 52 enables the amorphous carbon film as diamond-like carbon to be efficiently formed on an outer circumferential surface of the piston ring 52 and an inner circumferential surface of the cylinder liner 17.

FIG. 4B illustrates the example of using the piston ring 52 as the sliding member, using the cylinder liner 17 as the reception member, and forming a carbon film 62 on the sliding surface belonging to the cylinder liner 17 and contacting with the piston ring 52. The carbon film 62 contains carbon as a main component. The gas compressor is made to operate for generating compressed gas. The piston ring 52 thereby slides against the cylinder liner 17, resulting in that the tribochemical reaction turns the carbon film 62 into the amorphous carbon films.

Also in this case, forming the carbon film 62 on the sliding surface of the cylinder liner 17 enables the amorphous carbon film as diamond-like carbon to be efficiently formed on an outer circumferential surface of the piston ring 52 and an inner circumferential surface of the cylinder liner 17.

When the gas compressor is made to operate without formation of either the carbon film 60 or the carbon film 62 on the sliding surface of the piston ring 52 or the cylinder liner 17, the amorphous carbon film having a low friction coefficient fails to be formed on the entire sliding surfaces by the tribochemical reaction. This applies even when wear of the piston ring 52 made of a resin results in separation of a carbon component included in additive components of the resin. In addition, the amorphous carbon film of which carbon content is higher in its surface part than in its inner part as illustrated in FIG. 3B is hardly formed in such a case. From this point, the carbon film 60 or the carbon film 62 is previously formed on the sliding surface of the piston ring 52 or the cylinder liner 17. Thereby, the amorphous carbon film having a certain thickness can be stably formed on the entire sliding surfaces of the sliding member and the reception member.

A surplus of the carbon film 60 does not constitute the amorphous carbon films, and is sent out to an outside along with generated compressed gas.

Such a carbon film 60 or 62 may be formed by adhering of flake graphite powder or amorphous graphite powder. The flake graphite powder and the amorphous graphite powder are obtained by pulverizing and granulating natural graphite. The carbon component of the carbon film 60 or 62 is not limited to graphite carbon, and may be glassy carbon. The carbon film 60 or 62 can be formed by making powder carbon adhere to the sliding surface of the piston ring 52 or the cylinder liner 17, or also by applying and drying a slurry-like liquid that contains graphite or the like. The carbon film 60 or 62 can also be formed by chemical vapor deposition (CVD).

FIG. 4C illustrates the example of using piston rings 52 and 53 as the sliding members and using the cylinder liner 17 as the reception member. Preferably, the piston ring 53 (second sliding member) is a ring-shaped member made of a resin and sliding relatively against the reception member, similarly to the piston ring 52 (first sliding member), and contains graphite as carbon. In this case, a content of the graphite in the piston ring 53 is larger than that of the piston ring 52. Particularly, the graphite content of the piston ring 53 (second sliding member) is extremely high. In this case, the graphite content of the piston ring 53 (second sliding member) is preferably in a range of 10 to 40 mass % when the graphite is used as an additive in the resin such as PTFE, PEEK, or polyimide. When the piston ring 53 (second sliding member) is made of graphite as a main component, a proportion of this main component is preferably in a range of 95 to 100 mass %. Also in this case, the gas compressor is driven. In other words, the piston 18 is driven, thereby causing the piston rings 52 and 53 to slide against the reception member. As a result, the amorphous carbon film is formed, by the carbon (graphite) derived from the piston ring 53, on the entire sliding surfaces of the cylinder liner 17 and the piston rings 52 and 53. In this case, the amorphous carbon films are formed from fine wear particles of the piston ring 53 by the tribochemical reaction. In other words, the piston ring 53 is a member that supplies the graphite for forming the amorphous carbon films by the tribochemical reaction. Also in this case, the amorphous carbon film as diamond-like carbon can be efficiently formed on outer circumferential surfaces of the piston rings 52 and 53 and an inner circumferential surface of the cylinder liner 17.

According to one embodiment, the piston rings 50 and 52 are preferably desulfurized members from the viewpoint of preventing compressed gas from containing impurities. Before the piston rings 50 and 52 are incorporated into the gas compressor, the piston rings 50 and 52 are preferably subjected to the desulfurization treatment. For example, this treatment exposes the piston rings 50 and 52 to a hydrogen atmosphere. Sulfur that is among sulfur contained in PPS or the like in the piston rings 50 and 52 and that is contained in low molecules reacts with hydrogen in the hydrogen atmosphere. The sulfur thereby turns into hydrogen sulfide gas, and is then easily released to an outside. Removing such sulfur from the piston rings 50 and 52 can suppress compressed gas from containing, as impurities, the gas that contains the sulfur derived from the piston rings 50 and 52. Particularly, when the gas compressor is driven for hydrogen gas as gas to be compressed, sulfur in the piston rings 50 and 52 easily reacts with the hydrogen so as to generate a hydrogen sulfide gas to be contained as impurities in the hydrogen gas. For example, when the compressed hydrogen gas is used in a fuel cell vehicle, the standard (ISO-14687-2: 2012) requests that a concentration (a value determined based on that all sulfur compounds are regarded as hydrogen sulfide) of total sulfur compounds be equal to or smaller than 0.004 ppm. From this point, the piston rings 50 and 52 are preferably desulfurized members. For example, the piston rings 50 and 52 are preferably exposed to a hydrogen atmosphere before being incorporated into the gas compressor. Further, the rider ring 50 and the rod packing 54 are also preferably desulfurized members for the similar reason. For example, the rider ring 50 and the rod packing 54 are preferably exposed to a hydrogen atmosphere before being incorporated into the gas compressor. The hydrogen atmosphere is an atmosphere of 200° C. and 5.5 MPa, for example. The piston rings 50 and 52, the rider ring 50, and the rod packing 54 are left in the hydrogen atmosphere for 7 hours, for example. As a hydrogen atmosphere pressure and a hydrogen atmosphere temperature are higher, reaction between the hydrogen and the sulfur is more promoted. A high pressure and a high temperature are thus preferable. When a hydrogen atmosphere temperature is excessively high, resins of the piston rings 50 and 52, the rider ring 50, and the rod packing 54 are, however, easily damaged. From this point, a hydrogen atmosphere temperature is preferably in a range of 100° C. to 200° C.

As described above, the piston rings 50 and 52, the rider ring 50, and the rod packing 54 are desulfurized, for example, exposed to a hydrogen atmosphere. This can significantly postpone a timing of replacing a filter. The filter conventionally uses activated carbon or the like to secure high-purity compressed gas.

According to one embodiment, the sliding member is formed of a resin material containing fluorine, as described above. However, a fluorine content in the amorphous carbon film formed on each of the sliding surfaces is smaller in its surface part than in its inner part on an inner side of the surface part. The surface part of the amorphous carbon film accordingly contains less fluorine than the inner part, and contains a large content of carbon. The amorphous carbon film containing a small content of impurities can be thus formed, and a wear property is also improved.

According to one embodiment, the sliding member is formed of a resin material containing an additive that contains sulfur, while the amorphous carbon film formed on each of the sliding surfaces is free of sulfur. Thus, the amorphous carbon film containing a small content of impurities, i.e., a diamond-like carbon film can be formed, and a wear property is improved.

Further, the sliding member is a desulfurized member, for example, a member that has been previously exposed to a hydrogen atmosphere. The sliding member contains, in the resin, the additive containing sulfur. The additive is, for example, a reinforcing material for improving wear resistance. In some cases, a part of this sulfur, however, turns into impurity gas in compressed gas. Particularly when hydrogen gas is the compressed gas, a part of the sulfur easily reacts with the hydrogen to turn into hydrogen sulfide gas. For this reason, the sliding member is desulfurized in order that impurity gas is then hardly generated. For example, the sliding members that have been previously exposed to a hydrogen atmosphere are used as the rider ring 50, the piston ring 52, and the rod packing 54.

According to one embodiment, a ring-shaped sliding member (second sliding member) of which carbon content is larger than that of the different sliding member (first sliding member) is provided also as the sliding member. The ring-shaped sliding member slides relatively against the reception member. The ring-shaped sliding member containing a large content of carbon is worn by sliding, thereby separating a resin. A carbon component in the separated resin can stably form into the amorphous carbon films of a certain film thickness by the tribochemical reaction.

Further, the ring-shaped sliding member (second sliding member) containing a large content of carbon is preferably a desulfurized member. For example, the ring-shaped sliding member is preferably exposed to a hydrogen atmosphere before being incorporated into the gas compressor, from the viewpoint that compressed gas can be thereby prevented from containing impurities.

The gas compressor and the gas compressor manufacturing method according to the present invention are described above in detail. As a matter of course, the present invention is, however, not limited to the above-described embodiments. Various improvements and modifications may be made without departing from the essence of the present invention.

### REFERENCE SIGNS LIST

3 Drive unit
10 Gas compressor
12 Suction pipe
14 Compression chamber
16 Cylinder
17 Cylinder liner
18 Piston
20 Discharge pipe
22 Cooler
24 Cylinder head
31 Piston rod
32 Crosshead guide
33 Crosshead
34 Connecting rod
35 Crankcase
36 Crankshaft
37 Power transmission mechanism
38 Drive motor
50 Rider ring
52, 53 Piston ring
54 Rod packing
60, 62 Carbon film

1. A gas compressor that compresses gas, comprising:
a cylinder liner;
a piston member including
a piston configured to reciprocate in an inner space of the cylinder liner, and
a piston rod connected to the piston; and
a first sliding member made of a resin, having a ring shape, and provided on one of the piston member and the cylinder liner, the first sliding member configured to slide relatively against a reception member while another of the piston member and the cylinder liner serves as the reception member that receives sliding,
wherein an amorphous carbon film is formed on a sliding surface of each of the first sliding member and the reception member, and
a carbon content in the amorphous carbon film formed on each of the sliding surfaces is larger in a surface part than in an inner part on an inner side of the surface part, the surface part and the inner part belonging to the amorphous carbon film.

2. The gas compressor according to claim 1, wherein
the first sliding member is formed of a resin material containing an additive that contains sulfur,
the amorphous carbon film formed on each of the sliding surfaces is free of sulfur, and
a pipe connected to a hydrogen gas source is connected to a compression chamber of the gas compressor.

3. The gas compressor according to claim 1, wherein
the first sliding member is formed of a resin material containing an additive that contains sulfur, and
the amorphous carbon film formed on each of the sliding surfaces is free of sulfur.

4. The gas compressor according to claim 1, wherein
the first sliding member is formed of a resin material containing fluorine, and
a fluorine content in the amorphous carbon film formed on each of the sliding surfaces is smaller in the surface part than in the inner part on an inner side of the surface part.

5. The gas compressor according to claim 1, wherein
the first sliding member is a desulfurized member.

6. A gas compressor that compresses gas, comprising:
a cylinder liner;
a piston member including,
a piston configured to reciprocate in an inner space of the cylinder liner, and
a piston rod connected to the piston;
a first sliding member made of a resin, having a ring shape, and provided on one of the piston member and the cylinder liner, the first sliding member configured to slide relatively against a reception member while another of the piston member and the cylinder liner serves as the reception member that receives sliding; and
a second sliding member having a ring shape and provided on the one of the piston member and the cylinder liner, the second sliding member configured to slide relatively against the reception member and thereby supply graphite for forming an amorphous carbon film, a content of graphite in the second sliding member being larger than in the first sliding member.

7. A method for manufacturing the gas compressor according to claim 1,
the method comprising:
forming a carbon film on a surface of the first sliding member or the reception member, the carbon film containing carbon as a main component; and
driving the piston member so as to slide the first sliding member relatively against the reception member, thereby causing an amorphous carbon film to be formed, from the carbon film, on a sliding surface of the first sliding member and a sliding surface of the reception member, the amorphous carbon film being more hardened than the carbon film.

8. A method for manufacturing a gas compressor that is configured to compress gas and that includes: a cylinder liner; a piston member including a piston configured to reciprocate in an inner space of the cylinder liner, and a piston rod connected to the piston; a first sliding member made of a resin, having a ring shape, and provided on one of the piston member and the cylinder liner, the first sliding member configured to slide relatively against a reception member while another of the piston member and the cylinder liner serves as the reception member that receives sliding; and a second sliding member made of a resin, having a ring shape, and configured to slide relatively against the reception member, a carbon content in the second sliding member being larger than in the first sliding member,
the method comprising:
driving the piston member so as to slide the first sliding member and the second sliding member relatively against the reception member, thereby causing an amorphous carbon film to be formed on a sliding surface of the reception member, a sliding surface of the first sliding member, and a sliding surface of the second sliding member, the amorphous carbon film being formed of carbon derived from the second sliding member.

9. The method for manufacturing the gas compressor according to claim 8, wherein a graphite content in the second sliding member is larger than in the first sliding member, and the second sliding member supplies the graphite, thereby forming the amorphous carbon film.

10. The method for manufacturing the gas compressor according to claim 8, comprising:
exposing the second sliding member to a hydrogen atmosphere before incorporating the second sliding member into the gas compressor.

11. The method for manufacturing the gas compressor according to 10 claim 7, comprising:
exposing the first sliding member to a hydrogen atmosphere before incorporating the first sliding member into the gas compressor.

12. The method for manufacturing the gas compressor according to 11 claim 7, wherein the first sliding member is formed of a resin material containing an additive that contains sulfur, and
the amorphous carbon film formed on each of the sliding surfaces is free of sulfur.

13. The method for manufacturing the gas compressor according to 12 claim 7, wherein the gas compressor sucks hydrogen gas, compresses the sucked hydrogen gas, and sends out the compressed hydrogen gas.

14. The gas compressor according to claim 2, wherein
the first sliding member is formed of a resin material containing fluorine, and
a fluorine content in the amorphous carbon film formed on each of the sliding surfaces is smaller in the surface part than in the inner part on an inner side of the surface part.

15. The gas compressor according to claim 3, wherein
the first sliding member is formed of a resin material containing fluorine, and
a fluorine content in the amorphous carbon film formed on each of the sliding surfaces is smaller in the surface part than in the inner part on an inner side of the surface part.

16. The gas compressor according to claim 2, wherein
the first sliding member is a desulfurized member.

17. The gas compressor according to claim 3, wherein
the first sliding member is a desulfurized member.

18. The gas compressor according to claim 4, wherein
the first sliding member is a desulfurized member.

19. The method for manufacturing the gas compressor according to claim 8, comprising:
exposing the first sliding member to a hydrogen atmosphere before incorporating the first sliding member into the gas compressor.

20. The method for manufacturing the gas compressor according to claim 8, wherein the first sliding member is formed of a resin material containing an additive that contains sulfur, and
the amorphous carbon film formed on each of the sliding surfaces is free of sulfur.
